(19) United States
(12) Patent Application Publication
(10) Pub. No.: US 2004/0018324 A1
(43) Pub. Date: Jan. 29, 2004

(54) Packaging tape with multi-function protrusions

(76) Inventor: Xudong Sun, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/457,946

(22) Filed: Jun. 9, 2003

(30) Foreign Application Priority Data
Jul. 26, 2002 (TW) 91211456

(51) Int. Cl. F16L 1/00

(52) U.S. Cl. 428/34.1

(57) ABSTRACT

A packaging tape (1) for packing a plurality of connectors (2) includes a plurality of receiving portions (3) for receiving the connectors. A protrusion (32) protrudes from a bottom wall (30) of each receiving portion. The protrusion includes a supporting stage (322), and a locating stage (320) protruding from the supporting stage. A cross sectional area of the locating stage is less than that of the supporting stage. The locating stage is received in an opening (24) of a corresponding connector. The receiving portion also includes a plurality of sidewalls (31). A plurality of supporting bars (34) is provided at respective junctions of the sidewalls and the bottom wall, for supporting the connector. The protrusion is offset such that it prevents the connector from being incorrectly received in the receiving portion.

### BACKGROUND OF THE INVENTION

1. Field of the Invention

The present invention relates to a packaging tape, and particularly to a packaging tape with protrusions for packing a plurality of electrical connectors.

2. Description of the Prior Art

Packaging tape is widely used for packing electrical connectors and providing convenient transportation of the connectors. Packaging tape can receive a plurality of connectors, and can be located at an assembly line for facilitating picking up and placing the connectors on workpieces such as circuit boards. FIG. 4 shows a conventional packaging tape 9 for receiving a plurality of connectors 8. The packaging tape 9 can be spooled for transportation of the connectors 8. At an assembly line (not shown), the packaging tape 9 is unspooled for assembly of the connectors 8 to other workpieces. Thus, the connectors 8 located in the packaging tape 9 are conveniently picked by a pick-up mechanism (not shown), and then assembled with corresponding circuit boards.

Referring to FIG. 5, each receiving portion 10 of the packaging tape 9 and each connector 8 have a same rectangular profile. Further, the receiving portion 10 of the packaging tape 9 has no proper configuration to prevent the connector 8 from being incorrectly placed in the receiving portion 10. Thus, the connectors 8 are liable to be received in the receiving portions 10 in incorrect orientations. Subsequently, in assembly, the connectors 8 are attached incorrectly to the circuit boards. This results in costly failure rates on automatic assembly lines, and wastage of products.

A new packaging tape which overcomes the above-mentioned problems is desired.

### SUMMARY OF THE INVENTION

An object of the present invention is to provide a packaging tape for packing a plurality of connectors, in which the packaging tape prevents the connectors from being incorrectly received therein.

In order to achieve the above object, a packaging tape or tray for packing a plurality of connectors in accordance with a preferred embodiment of the present invention comprises a plurality of receiving portions for receiving the connectors. A protrusion protrudes from a bottom wall of the receiving portion, and is offset from a center of the bottom wall. The protrusion comprises a supporting stage and a locating stage protruding from the supporting stage. A cross sectional area of the locating stage is less than that of the supporting stage. The locating stage is received in an opening of the connector. The receiving portion comprises a plurality of sidewalls. A plurality of supporting bars is provided at a junction of the sidewalls and the bottom wall. A height of each supporting bar is equal to that of the supporting stage.

Other objects, advantages and novel features of the present invention will become more apparent from the following detailed description when taken in conjunction with the accompanying drawings, in which:

### BRIEF DESCRIPTION OF THE DRAWINGS

FIG. 1 is an isometric view of a packaging tape in accordance with the preferred embodiment of the present invention, together with an electrical connector ready to be received therein and two electrical connectors already received therein;

FIG. 2 is an enlarged view of a circled portion II of FIG. 1;

FIG. 3 is a cross-sectional view taken along line III-III of FIG. 1;

FIG. 4 is an isometric view of a conventional packaging tape, together with an electrical connector ready to be received therein and two electrical connectors already received therein; and

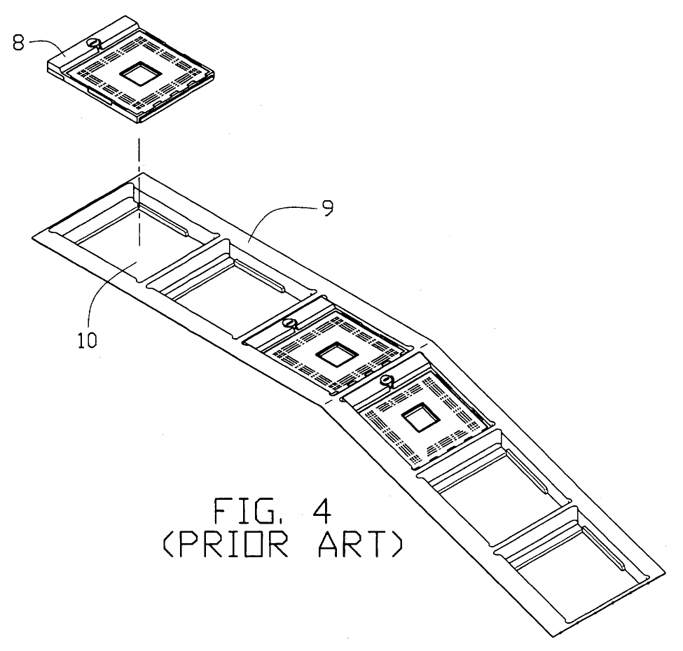

FIG. 5 is similar to FIG. 4, but showing the electrical connector ready to be received therein in an incorrect orientation.

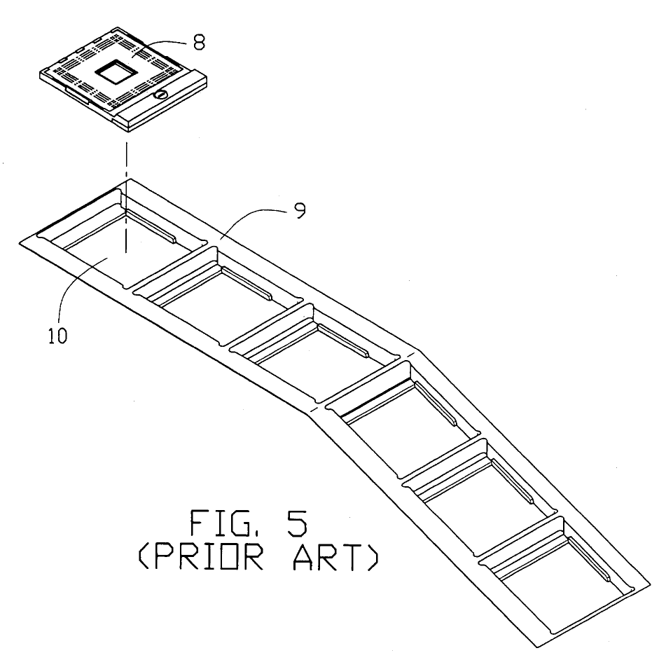

### DESCRIPTION OF THE PREFERRED EMBODIMENT

Reference will now be made to the drawings to describe the present invention in detail.

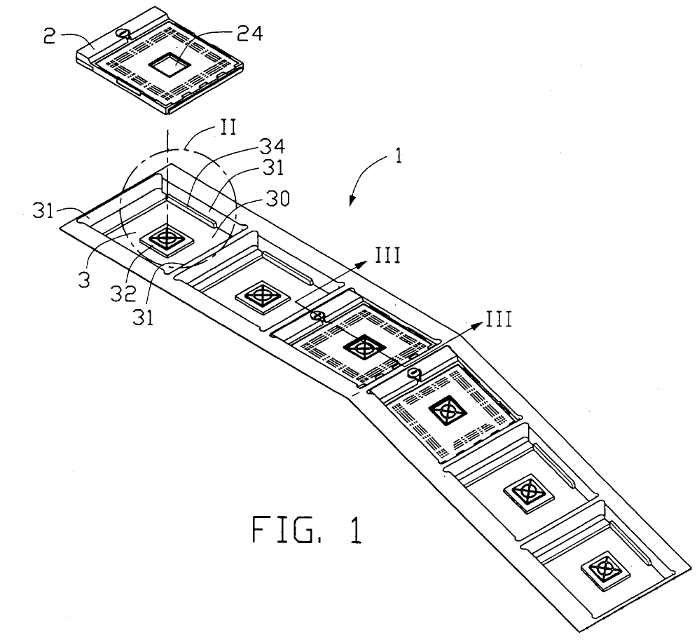

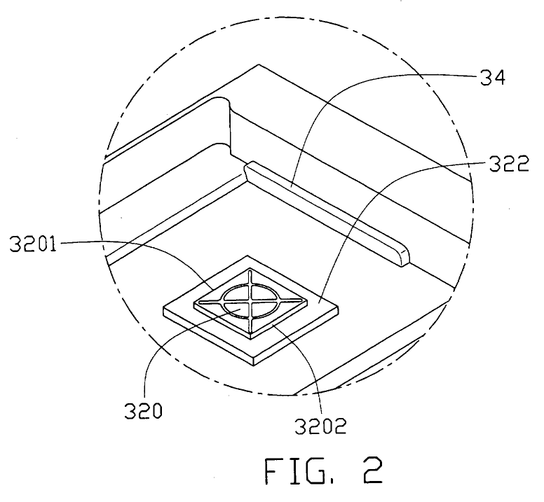

Referring to FIGS. 1 and 2, a packaging tape 1 in accordance with the preferred embodiment of the present invention is for receiving a plurality of rectangular connectors 2. The packaging tape 1 comprises a plurality of receiving portions 3. Each connector 2 defines a rectangular central opening 24 therein.

Each receiving portion 3 of the packaging tape 1 comprises a recess. A profile of the receiving portion 3 is similar to that of the connector 2. The receiving portion 3 further comprises a bottom wall 30, and a plurality of sidewalls 31. A stepped protrusion 32 protrudes upwardly from the bottom wall 30 of the receiving portion 3. The protrusion 32 is offset from a center of the bottom wall 30. The protrusion 32 comprises a lower supporting stage 322, and a locating stage 320 protruding upwardly from the supporting stage 322. An area of a horizontal cross section of the locating stage 320 is less than that of the supporting stage 322. Four supporting bars 34 are provided at junctions of the bottom wall 30 and the sidewalls 31 respectively. A height of each supporting bar 34 is equal to that of the supporting stage 322.

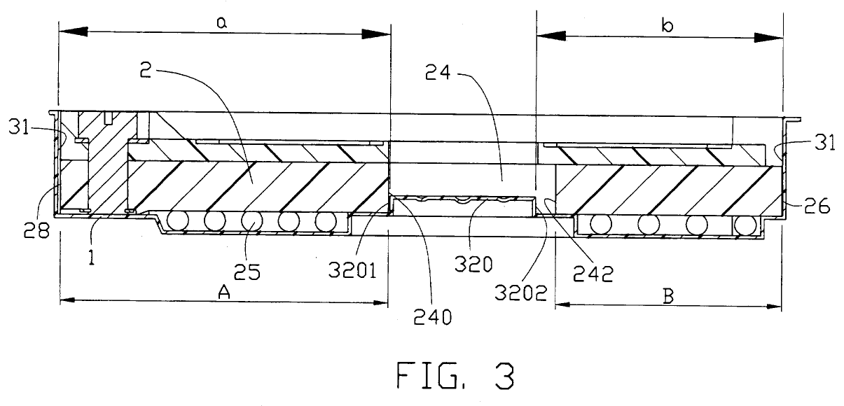

Referring also to FIG. 3, the locating stage 320 comprises a first side edge 3201 and an opposite second side edge 3202. A distance between the first side edge 3201 and an opposing one of the sidewalls 31 is represented by ‘a’. A distance between the second side edge 3202 and an opposing one of the sidewalls 31 is represented by ‘b’. The distance ‘a’ is greater than the distance ‘b’. The opening 24 of the connector 2 is received in the locating stage 320 of the protrusion 32. The opening 24 is bounded by a first inside wall 240, and an opposite second inside wall 242. A distance between the first inside wall 240 and a corresponding first outside wall 28 of the connector 2 is represented by ‘A’. A distance between the second inside wall 242 and a corresponding second outside wall 26 of the connector 2 is represented by ‘B’. Distance ‘A’ is substantially equal to distance ‘a’, and is greater than distance ‘B’. Distance ‘B’ is less than distance ‘b’. A bottom wall of the connector 2 has a plurality of solder balls 25, for connecting the connecter 2 with a circuit board (not shown) after removal of the connecter 2 from the packaging tape 1.

Distance ‘A’ is substantially equal to distance ‘a’ and greater than distance ‘B’, and distance ‘B’ is less than distance ‘b’. Thus, in loading, the connector 2 can only be received in the corresponding receiving portion 3 of the packaging tape 1 in the one correct orientation. The locating stage 320 of the protrusion 32 is received in the opening 24 of the connector 2. The supporting bars 34 of the packaging tape 1 support the connector 2. In addition, all inner edge portions of the connector 2 at the opening 24 are supported by the supporting stage 322 of the protrusion 32. Thus, a space is provided between a bottom wall of the connector 2 and the bottom wall 30 of the receiving portion 3. The solder balls 25 of the connector 2 are disposed in the space. Accordingly, the bottom wall 30 of the receiving portion 3 does not deform the solder balls 25. The solder balls 25 are able to remain coplanar with each other. From another viewpoint, the space may be deemed to be formed by the downward protrusion extending downwardly from a reference plane, i.e., supporting stage 322, on which the bottom face of the connector 2 is seated upon. When the connector 2 is later removed from the packaging tape 1 and attached to a circuit board, signal transmission between the connector 2 and the circuit board is reliable.

Distance ‘A’ is substantially equal to distance ‘a’ and is greater than distance ‘B’, and distance ‘B’ is less than distance ‘b’. This configuration prevents the connector 2 from being incorrectly received in the receiving portion 3 of the packaging tape 1 in a reversed orientation. This is because the locating stage 320 of the protrusion 32 could not be received in the opening 24 of the connector 2. Thus, when the connector 2 is later removed from the packaging tape 1, attachment of the connector 2 to the circuit board in a correct orientation is assured. Wastage of circuit board assemblies due to incorrect attachment of connectors 2 is reduced or even eliminated.

While a preferred embodiment in accordance with the present invention has been shown and described, equivalent modifications and changes known to persons skilled in the art according to the spirit of the present invention are considered within the scope of the present invention as defined in the appended claims.

What is claimed is:

1. A packaging tape comprising:
a plurality of receiving portions; and
a protrusion at a bottom of each of the receiving portions;
wherein the protrusion is offset such that it prevents an object from being incorrectly received in the receiving portion.

2. The packaging tape as described in claim 1, wherein each of the receiving portions comprises a plurality of sidewalls, and a bottom wall.

3. The packaging tape as described in claim 2, wherein a plurality of supporting bars is provided at respective junctions of the sidewall and the bottom wall of the receiving portion.

4. The packaging tape as described in claim 3, wherein each of the protrusions is stepped, and comprises a locating stage and a supporting stage.

5. The packaging tape as described in claim 4, wherein the locating stage protrudes from the supporting stage, and a cross sectional area of the locating stage is less than that of the supporting stage.

6. The packaging tape as described in claim 5, wherein a height of each of the supporting bars is substantially equal to that of the supporting stage.

7. The packaging tape as described in claim 1, wherein the packaging tape can be spooled for facilitating transportation thereof.

8. A packaging tape for packing a plurality of electrical connectors each defining an opening, the packaging tape comprising:
a plurality of receiving portions for receiving the connectors; and
a protrusion protruding from a bottom wall of each of the receiving portions;
wherein the protrusion prevents a respective connector from being incorrectly received in the receiving portion.

9. The packaging tape as described in claim 8, wherein each of the receiving portions comprises a plurality of sidewalls and a bottom wall.

10. The packaging tape as described in claim 9, wherein a plurality of supporting bars is provided at respective junctions of the sidewalls and the bottom wall.

11. The packaging tape as described in claim 10, wherein the supporting bars of the receiving portion support the respective connector.

12. The packaging tape as described in claim 10, wherein the protrusion is stepped, and comprises a locating stage and a supporting stage.

13. The packaging tape as described in claim 12, wherein a height of each of the supporting bars is equal to that of the supporting stage.

14. The packaging tape as described in claim 12, wherein the locating stage protrudes from the supporting stage, and a cross sectional area of the locating stage is less than that of the supporting stage.

15. The packaging tape as described in claim 14, wherein the locating stage is received in the opening of a respective connector.

16. The packaging tape as described in claim 8, wherein a profile of each of the receiving portions is similar to that of each of the connectors.

17. The packaging tape as described in claim 8, wherein the packaging tape can be spooled for facilitating transportation thereof.

18. A packaging tray assembly comprising:
a packaging tray defining a plurality of sequential receiving portions along an longitudinal direction of said packaging tray;
a plurality of electrical connectors disposed in the corresponding receiving portions, respectively,
each of said connectors configured to comply with the corresponding receiving portion, and being asymmetric along said longitudinal direction, and defining a bottom face and a center opening,
a plurality of solder balls extending downwardly from the bottom face and surrounding said center opening;
each of said receiving portions defining a reference plane on which the bottom face of the corresponding connector is seated upon;
each of said receiving portions including at least one protrusion integrally extending away from said reference plane in a vertical direction perpendicular to said longitudinal direction and asymmetric relative to the corresponding receiving portion along said longitudinal direction, so as to receiveably comply with said solder balls or the center opening of the corresponding connector only when said corresponding connector is correctly oriented in said corresponding receiving portion.

19. The assembly as described in claim 18, wherein said protrusion upwardly extends from the reference plane and is received in the center opening.

20. The assembly as described in claim 18, wherein said protrusion downwardly extends from the reference plane and receives said solder balls therein.
